(19) United States
(12) Patent Application Publication
(10) Pub. No.: US 2006/0065865 A1
(43) Pub. Date: Mar. 30, 2006

(54) Image readout apparatus

(75) Inventor: Kazuo Hakamata, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/239,223

(22) Filed: Sep. 30, 2005

(30) Foreign Application Priority Data
Sep. 30, 2004 (JP) 287316/2004

(51) Int. Cl. G01T 1/00

(52) U.S. Cl. 250/591

(57) ABSTRACT

Generation of flare components is reduced, and reduction of the amount 6f irradiated readout light is suppressed, in an image readout apparatus. The image readout apparatus is constituted by: an image recording medium, on which image information is recorded; a readout light source formed by electroluminescence elements that emit readout light as line light onto the image recording medium; and an erasing light source formed by electroluminescence elements that emit erasing light of a different frequency from that of the readout light onto the image recording medium to erase the image information therefrom. The readout light source and the erasing light source are integrally formed on a substrate.

### BACKGROUND OF THE INVENTION

1. Field of the Invention

The present invention relates to an image reading apparatus that reads out image information, which is recorded in an image recording medium, by irradiating line light onto the image recording medium, employing electroluminescence elements.

2. Description of the Related Art

In the field of medical X-ray radiography, various proposals have been made in order to reduce radiation dosages received by subjects, and to improve diagnostic properties. One such proposal is for an image recording medium that employs a photoconductor constituted by a selenium plate or the like having as its main component a-Se, which is sensitive to X-rays, as an electrostatic recording medium. Radiation, such as X-rays, that bear radiation image information is irradiated onto the electrostatic recording medium to record the radiation image information as an electrostatic latent image. One type of such an image recording medium employs a stimulable phosphor sheet that accumulates and records image information, and emits simulated phosphorescence corresponding to the image information when scanned with readout light. Another type of such an image recording medium is a solid state detector that records image information as an electrostatic latent image, and generates electrical current corresponding to the image information when scanned with readout light.

There is a method for reading out image information recorded in image recording media, by scanning readout light on the image recording media (as disclosed in, for example, Japanese Unexamined Patent Publication No. 2004-156908). An image recording medium and a readout light source, for irradiating the image recording medium with readout light, is provided in this method. Further, an erasing light source, for erasing image information that remains on the image recording medium, is provided between the readout light source and the image recording medium. The erasing light source is constituted by an electroluminescence panel (hereinafter, simply referred to as “EL panel”) formed on a glass substrate. The erasing light source is stacked as a layer on the image recording medium.

In a configuration such as that disclosed in Japanese Unexamined Patent Publication No. 2004-156908, the readout light is irradiated onto the image recording medium after passing through the erasing light source. However, when the readout light enters the glass substrate of the erasing light source, a portion of the readout light is reflected at the interface of the glass substrate and air (incident plane). This causes a problem that the amount of readout light, which is irradiated onto the image recording medium, is reduced.

### SUMMARY OF THE INVENTION

The present invention has been developed in view of the foregoing circumstances. It is an object of the present invention to provide an image readout apparatus that suppresses reduction of the amount of irradiated readout light, and also suppresses generation of flare components.

The first image readout apparatus of the present invention is an image readout apparatus for reading image information from an image recording medium, on which the image information is recorded, by irradiating readout light thereon, comprising:

a readout light source constituted by electroluminescence elements, for emitting the readout light onto the image recording medium as line light;

an erasing light source constituted by electroluminescence elements, for emitting erasing light of a frequency different from that of the readout light, to erase the image information recorded on the image recording medium; and

a substrate;

the readout light source and the erasing light source being integrally formed on the substrate.

Here, “integrally formed on the substrate” refers to a state in which the readout light source and the erasing light source are stacked as layers on a single substrate in the thickness direction thereof, or a state in which the readout light source and the erasing light source are alternately provided on a single substrate such that they are coplanar.

The electroluminescence elements that constitute the readout light source and the erasing light source may be either inorganic electroluminescence elements or organic electroluminescence elements. That is, in the case that the readout light source and the erasing light source are stacked as layers in the thickness direction of the substrate, organic electroluminescence elements may be stacked atop one other, or inorganic electroluminescence elements may be stacked atop organic electroluminescence elements.

A configuration may be adopted, wherein: a readout light emitting unit and an erasing light emitting unit are stacked as layers on the substrate; and the readout light source and the erasing light source are constituted by a multi photon emission element, which is integrally formed on the substrate by being stacked as layers thereon. In this case, a single readout light emitting unit and a single erasing light emitting unit may be provided, or a plurality of readout light emitting units and a plurality of erasing light emitting units may be provided.

In this case, a light emission control means, for separately controlling the operations of the readout light emitting unit and the erasing light emitting unit may be provided. The light emission timing of the readout light emitting unit and the light emission timing of the erasing light emitting unit may be controlled independently.

Similarly, in the case that the readout light source and the erasing light source are alternately provided on the substrate such that they are coplanar, the readout light source and the erasing light source may be constituted by either inorganic electroluminescence elements or organic electroluminescence elements. In this case, inorganic electroluminescence elements that emit at least light in a readout wavelength are selected as the readout light source, and inorganic electroluminescence elements that emit at least light in an erasing wavelength are selected as the erasing light source.

The second image readout apparatus of the present invention is an image readout apparatus for reading image information from an image recording medium, on which the image information is recorded, by irradiating readout light thereon, comprising:

a readout light source, for emitting the readout light onto the image recording medium as line light;

an erasing light source, for emitting erasing light of a frequency different from that of the readout light, to erase the image information recorded on the image recording medium; and

a substrate;

the readout light source and the erasing light source employing inorganic electroluminescence elements which are integrally formed with the substrate;

the readout light source being constituted by a plurality of stripe regions of the electroluminescence elements that emit light of a readout frequency; and

the erasing light source being constituted by a plurality of linear regions of the electroluminescence elements that emit light of an erasing frequency, which are provided between the stripe regions.

Note that the inorganic electroluminescence elements may be those that emit readout light or those that emit erasing light. In the case that the inorganic electroluminescence elements are those that emit readout light, the erasing light source may be of a configuration, in which wavelength converting layers that convert readout light to erasing light are provided at the regions for emitting erasing light. In the case that the inorganic electroluminescence elements are those that emit erasing light, the readout light source may be of a configuration, in which wavelength converting layers that convert erasing light to readout light are provided at the regions for emitting readout light.

According to the first image readout apparatus of the present invention, the readout light source and the erasing light source are integrally formed on the substrate. Therefore, dispersion of readout light and reflective loss, due to the readout light being irradiated onto image recording media after passing through a conventional erasing light source, can be prevented. Accordingly, generation of flare components of readout light can be suppressed, and reduction of light intensity can be prevented.

A configuration may be adopted, wherein: a readout light emitting unit and an erasing light emitting unit are stacked as layers on the substrate; and the readout light source and the erasing light source are constituted by a multi photon emission element, which is integrally formed on the substrate by being stacked as layers thereon. In this case, the readout light and the erasing light can be emitted with high current efficiency.

The image readout apparatus may further comprise a light emission control means, for separately controlling the operations of the readout light emitting unit and the erasing light emitting unit. In this case, emission timings of the readout light and the erasing light can be controlled independently, even if the readout light source and the erasing light source are constituted by multi photon emission elements.

According to the second image readout apparatus of the present invention, the readout light source is constituted by a plurality of stripe regions of the electroluminescence elements that emit light of a readout frequency; and the erasing light source is constituted by a plurality of linear regions, at which a wavelength converting layer for converting readout light emitted by the electroluminescence elements to erasing light, between the stripes of the readout light source. The readout light source and the erasing light source are integrally formed on the substrate. Therefore, dispersion of readout light and reflective loss, due to the readout light being irradiated onto image recording media after passing through a conventional erasing light source, can be prevented. Accordingly, generation of flare components of readout light can be suppressed, and reduction of light intensity can be prevented.

### BRIEF DESCRIPTION OF THE DRAWINGS

FIG. 1 is a schematic view that illustrates an image readout apparatus according to the present invention.

FIG. 2 is a schematic view that illustrates a panel light source according to a first embodiment, which is utilized in the image readout apparatus of the present invention.

FIG. 3 is a schematic view that illustrates a panel light source according to a second embodiment, which is utilized in the image readout apparatus of the present invention.

FIG. 4 is a schematic view that illustrates a panel light source according to a third embodiment, which is utilized in the image readout apparatus of the present invention.

FIG. 5 is a schematic view that illustrates a panel light source according to a fourth embodiment, which is utilized in the image readout apparatus of the present invention.

### DESCRIPTION OF THE PREFERRED EMBODIMENTS

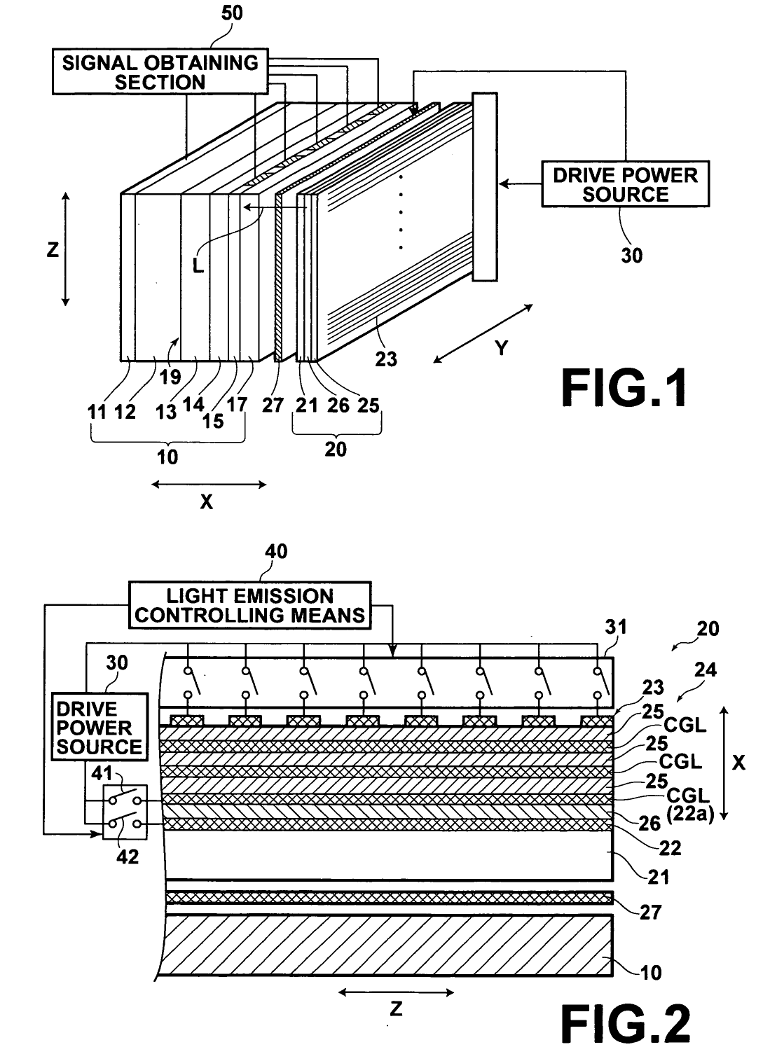

Hereinafter, embodiments of the image readout apparatus according to the present invention will be described in detail, with reference to the attached drawings. FIG. 1 is a schematic view that illustrates an image readout apparatus 1 according to a first embodiment of the present invention. The image readout apparatus 1 reads out image information recorded on an image recording medium 10, by irradiating readout light thereon.

First, the image recording medium 10 will be described with reference to FIG. 1. The image recording medium 10 is of the optical readout type, such as that disclosed in Japanese Unexamined Patent Publication No. 2000-284056. The image recording medium 10 comprises: a readout electrode layer 11; a readout light photoconductive layer 12; a charge transport layer 13; a recording light photoconductive layer 14; and second electrode layer 15; which are stacked atop one another.

The readout electrode layer 11 is constituted by NESA film or the like, and comprises a plurality of linear electrodes that extend parallel to each other in the direction of arrow Y. The linear electrodes are electrically insulated from each other. The readout photoconductive layer 12 is constituted by amorphous selenium, for example. The readout photoconductive layer 12 exhibits conductivity when irradiated by readout light, and generates charge pairs. The charge transport layer is stacked as a layer on the readout photoconductive layer. The charge transport layer acts substantially as an insulator with respect to negative charges, and acts substantially as a conductor with respect to positive charges. The recording light photoconductive layer 14 is constituted by amorphous selenium, for example. The recording light photoconductive layer exhibits conductivity when irradiated by recording electromagnetic waves (light or radiation), and generate charge pairs. Further, the second electrode layer 15, which is constituted by a plurality of linear electrodes that extend in the direction of arrow Z, is stacked as a layer on the recording light photoconductive layer. The linear electrodes of the second electrode layer 15 are constituted by a material that transmits the recording electromagnetic waves, such as ITO (Indium Tin Oxide) film.

Here, a charge accumulating section 19 is formed at the interface between the charge transport layer 13 and the recording photoconductive layer 14. That is, electrons, which are generated within the recording light photoconductive layer 14, move toward the readout electrode layer 11 due to the electric field formed between the readout electrode layer 11 and the second electrode layer 15. At this time, the movement of the electrons is restricted by the charge transport layer 13. Accordingly, charges that correspond to the amount of irradiated recording electromagnetic waves are accumulated as an electrostatic latent image, to record image information.

Here, when image information is recorded onto the image recording medium 10, high voltage is applied between the readout electrode layer 11 and the second electrode layer 15 by a signal obtaining section 50. Thereby, the readout electrode layer 11 becomes charged with negative charges, and the second electrode layer 15 becomes charged with positive charges. Next, recording electromagnetic waves are irradiated from the side of the second electrode layer 15, causing positive/negative charge pairs to be generated within the recording light photoconductive layer 14. Of the charge pairs, positive holes move toward the second electrode layer 14, combine with the negative charges thereon, and disappear. Meanwhile, electrons of the charge pairs move toward the readout electrode layer 11, but are restricted in their movement by the charge transport layer 13. Thereby, image information is recorded as an electrostatic latent image at the charge accumulating section 19.

When the image information recorded at the charge accumulating section 19 is to be read out, readout light, which is emitted from a panel light source 20 as line light and extends in the direction of arrow Y, is scanned in the direction of arrow X. Thereby, charge pairs corresponding to the amount of irradiated readout light are generated within the readout light photoconductive layer 12. Positive holes of the charge pairs pass through the charge transport layer, combine with the negative charges accumulated at the charge accumulating section 19, and disappear. Meanwhile, electrons of the charge pairs move toward the readout electrode layer 11 to combine with the positive charges thereat. Current flows through the readout electrode layer 11, when the positive holes and the negative charges combine thereat. The image information is read out, by the signal obtaining section 50 detecting these changes in current.

FIG. 2 is a schematic view that illustrates a panel light source 20 according to a first embodiment, which is utilized in the image readout apparatus 1 of the present invention. The panel light source 20 will be described with combined reference to FIGS. 1 and 2. The panel light source 20 is constituted by a multi photon emission element, comprising: an anode layer 22; a cathode layer 23; and a plurality of light emitting units 24, which are stacked as layers between the anode layer 22 and the cathode layer 23 (refer to Unexamined Japanese Patent Publication No. 2003-45676). The photo emission element is stacked as a layer on a light transmissive substrate 21, such as a glass substrate. An image focusing optical system 27 constituted by an SLP (Selfoc Lens Plate) having a great focal depth, for example, is provided between the image recording medium 10 and the panel light source 20. The readout light and the erasing light emitted from the panel light source 20 is focused onto the image recording medium by the image focusing optical system 27.

The anode layer 22 is a light transmissive conductive layer, such as that formed by ITO film, and is deposited as a planar film on the substrate 21. The cathode layer 23 is a conductive layer, constituted by a plurality of linear electrodes which are arranged as stripes. The panel light source 20 is arranged such that the side of the substrate 21 faces the image recording medium 10. The readout light and the erasing light pass through the substrate 21 before being irradiated onto the image recording medium 10.

Each light emitting unit 24 of the multi photon emission element is constituted by structural elements of a conventional organic EL element, from which an anode and a cathode have been removed. Specific examples of the structural elements of a conventional organic EL element are: an anode layer, a light emitting layer, and a cathode layer; an anode layer, a hole transport layer, a light emitting layer, and a cathode layer; and an anode layer, a hole transport layer, a light emitting layer, a charge transport layer, an electron injecting layer, and a cathode layer. Each light emitting unit 24 is partitioned by a layer 22a that forms an equipotential surface (hereinafter, referred to as a CGL 22a (Charge Generation Layer)).

The multi photon emission element of FIG. 2 comprises: readout light emitting units 25 for emitting readout light; and an erasing light emitting units 26 for emitting erasing light. The readout light emitting units 25 constitute a readout light source, and the erasing light emitting unit 26 constitutes an erasing light source. Specifically, as illustrated in FIG. 2, the anode layer 22 is stacked on the substrate 21, and the erasing light emitting unit 25 that emits erasing light, which is a red colored light, for example, is stacked on the anode layer 22. The plurality of readout light emitting units 25 that emit readout light, which is a blue light, for example, are stacked as layers on the erasing light emitting unit 26. The cathode layer 23 is stacked on the readout light emitting units 25.

The anode layer 22 and the cathode layer 23 are electrically connected to a drive power source 30. The drive power source 30 outputs drive voltages, for causing the readout light or the erasing light to be emitted, to the anode layer 22 and the cathode layer 23. Specifically, the drive power source 30 is connected to the anode layer 22 via a switching element 41, and the drive power source 30 is connected to the cathode layer 23 via switching elements 31. Further, the drive power source 30 is connected to the CGL 22a, which is stacked on the erasing light emitting unit 26, via a switching element 42. The operations of the switching elements 31, 41, and 42 are controlled by a light emission controlling means 40.

When readout light is to be emitted from the multi photon emission element, the switching element 41 is switched ON, the switching element 42 is switched OFF, and the switching elements 31 are sequentially switched ON in a scanning direction (indicated by arrow Z). Thereby, the drive voltages are applied between the CGL 22a and the linear cathodes of the cathode layer 23, and readout light is emitted from the readout light emitting units 25 sandwiched between the CGL 22a and the cathode layer 23 as scanning linear light.

On the other hand, when erasing light is to be emitted from the multi photon emission element, the switching element 41 is switched OFF, the switching element 42 is switched ON, and all of the switching elements 31 are switched ON. Thereby, the drive voltage is applied between the anode layer 22 and the cathode layer 23, causing readout light and erasing light to be emitted from the readout light emitting unit 25 and the erasing light emitting unit 26, which are sandwiched between the anode layer 22 and the cathode layer 23.

Next, an operation of the image readout apparatus will be described with reference to FIG. 1 and FIG. 2. First, when image information is read out from the image recording medium 10, drive voltages are applied to the readout light emitting units 25 from the drive power source 30, according to control by the light emission controlling means 40. Thereby, readout light is scanned and irradiated onto the image recording medium as line light. At this time, the signal obtaining section 50 sequentially obtains image information from the portions of the image recording medium 10, which are irradiated by the readout light.

Following irradiation of the readout light, erasing light is irradiated on the image recording medium 10, to erase image information remaining thereon. Specifically, drive voltage is applied to the readout light emitting units 25 and the erasing light emitting unit 26 from the drive power source 30 according to control by the light emission controlling means 40. Thereby, readout light and erasing light are irradiated onto the image recording medium 10. Irradiation of the readout light and the erasing light erases the image information which had remained on the image recording medium 10.

According to the embodiment described above, the readout light source and the erasing light source are integrally formed on the substrate 21. Therefore, dispersion of readout light and reflective loss, due to the readout light being irradiated onto the image recording medium 10 after passing through a conventional erasing light source, can be prevented. Accordingly, generation of flare components of readout light can be suppressed in the image readout apparatus 1, and reduction of light intensity can be prevented.

Note that in the embodiment above, the readout light source and the erasing light source are constituted by a multi photon emission element, comprising: the readout light emitting units 25; and an erasing light emitting unit 26, which are stacked as layers on the substrate. Therefore, the readout light and the erasing light can be emitted with high current efficiency.

In the above embodiment, the light emission controlling means 40, for separately controlling the operations of the readout light emitting units 25 and the erasing light emitting unit 26, is provided. Therefore, the light emission timing of the readout light emitting units 25 and the light emission timing of the erasing light emitting unit 26 can be controlled independently, even in the case that the readout light source and the erasing light source are integrally formed by employing the multi photon emission element.

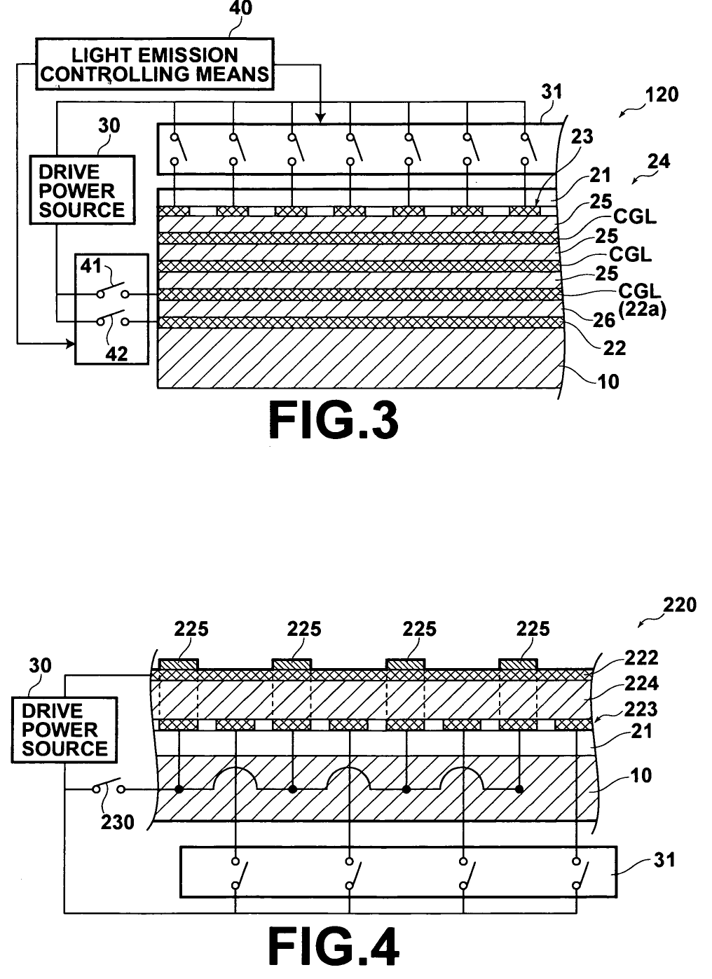

FIG. 3 is a schematic view that illustrates a panel light source 120 according to a second embodiment, which is utilized in the image readout apparatus 1 of the present invention. The panel light source 120 will be described with reference to FIG. 3. Note that structural elements of the panel light source 120, which are the same as those of the panel light source 20, are denoted by the same reference numerals, and detailed descriptions thereof will be omitted. In addition, the image focusing optical system 27 has been omitted from FIG. 3 and from the following description. However, the image focusing optical system 27 may be provided between the image recording medium 10 and the panel light source 120.

The panel light source 120 of FIG. 3 differs from the panel light source 20 of FIG. 2 in the layer structure of the light emitting units 24. Specifically, a cathode layer 23, formed of aluminum or the like, is stacked on the substrate 21. A plurality of readout light emitting units 25 are stacked as layers on the cathode layer 23, with CGL's interposed therebetween. The erasing light emitting unit 26 is stacked as a layer on the readout light emitting units 25, with a CGL interposed therebetween. An anode layer 22, formed of transparent electrodes such as ITO film, is stacked on the erasing light emitting unit 26. That is, the panel light source 22 is constructed such that the side of the anode layer 22 faces the image recording medium 10. Readout light and erasing light are irradiated onto the image recording medium 10 after being transmitted through the anode layer 22.

In the panel light source 120 as illustrated in FIG. 3 as well, the readout light source and the erasing light source are integrally formed on the substrate 21. Therefore, dispersion of readout light and reflective loss, due to the readout light being irradiated onto the image recording medium 10 after passing through a conventional erasing light source, can be prevented. Accordingly, generation of flare components of readout light can be suppressed in the image readout apparatus 1, and reduction of light intensity can be prevented.

FIG. 4 is a schematic view that illustrates a panel light source 220 according to a third embodiment, which is utilized in the image readout apparatus 1 of the present invention. The panel light source 220 will be described with reference to FIG. 4. Note that structural elements of the panel light source 220, which are the same as those of the panel light source 20 of FIG. 2, are denoted by the same reference numerals, and detailed descriptions thereof will be omitted. In addition, the image focusing optical system 27 has been omitted from FIG. 4 and from the following description. However, the image focusing optical system 27 may be provided between the image recording medium 10 and the panel light source 220.

The panel light source 220 of FIG. 4 differs from the panel light source 20 of FIG. 2 in the structures of the readout light source and the erasing light source. That is, in the panel light source 220, the readout light source and the erasing light source are constituted by an inorganic electroluminescence element, which is integrally formed on the substrate 21. The readout light source is constituted by a plurality of stripe regions of the inorganic electroluminescence element that emit light in a readout frequency. The erasing light source is constituted by a plurality of linear regions of the inorganic electroluminescence element, in gaps between the stripe readout light source regions, that emit light in an erasing frequency.

Specifically, the panel light source 220 is constituted by an inorganic EL panel, comprising: a planar anode 222; cathodes 223, which are constituted by a plurality of linear electrodes arranged in stripes; and an inorganic EL panel, which is sandwiched between the anode 222 and the cathodes 223. The inorganic EL panel emits readout light when drive voltage is applied between the anode 222 and the cathodes 223 from the drive power source 30. Accordingly, when readout light is to be irradiated onto the image recording medium 10 as line light, drive voltages are selectively applied to the cathode 223 corresponding to the regions at which readout light is to be emitted, by the switching elements 31. Thereby, readout light is scanned and emitted.

Meanwhile, wavelength converting layers 225, for converting the readout light emitted by the inorganic electroluminescence elements to erasing light, are stacked within the gaps between the stripe readout light source regions. Drive voltages are applied to the cathode 223 at the regions for emitting erasing light, by a switching element 230, to cause the panel light source 220 to irradiate erasing light onto the image recording medium 10.

In the panel light source 220 as illustrated in FIG. 4 as well, the readout light source and the erasing light source are integrally formed on the substrate 21. Therefore, dispersion of readout light and reflective loss, due to the readout light being irradiated onto the image recording medium 10 after passing through a conventional erasing light source, can be prevented. Accordingly, generation of flare components of readout light can be suppressed in the image readout apparatus 1, and reduction of light intensity can be prevented.

Note that FIG. 4 illustrates a case in which the inorganic EL element emits readout light, and the wavelength converting layers 225 are provided at the erasing light source side. Alternatively, the inorganic EL element may emit erasing light, and wavelength converting layers may be provided at the readout light source side.

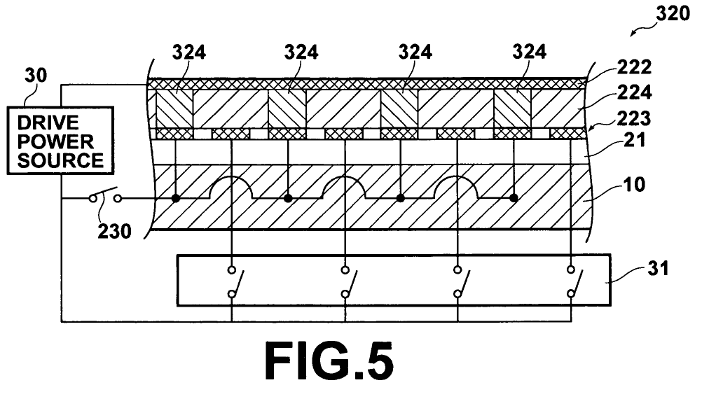

In addition, FIG. 4 illustrates a case in which the erasing light source is constituted by the wavelength converting layers 225 being stacked atop the inorganic EL element, which emits readout light, as a manner in which the readout light source and the erasing light source are integrally formed on the substrate 21. Alternatively, the readout light source may be constituted by a plurality of linear EL elements 224 that emit readout light, arranged in stripes, and the erasing light source may be constituted by a plurality of linear EL elements 324 that emit erasing light, provided in the gaps between the stripe EL elements 224. Such a construction is embodied by a panel light source 320 illustrated in FIG. 5. In this case, the EL elements 224 and 324 may be either organic or inorganic EL elements. An EL element that emits light of at least a readout wavelength and an EL element that emits light of at least an erasing wavelength are appropriately selected.

According to each of the embodiments described above, the readout light source and the erasing light source are integrally formed on the substrate 21. Therefore, dispersion of readout light and reflective loss, due to the readout light being irradiated onto the image recording medium 10 after passing through a conventional erasing light source, can be prevented. Accordingly, generation of flare components of readout light can be suppressed in the image readout apparatus 1, and reduction of light intensity can be prevented.

In the embodiments of FIG. 2 and FIG. 3, the readout light source and the erasing light source are constituted by a multi photon emission element, comprising: the readout light emitting units 25 that emit readout light; and an erasing light emitting unit 26 that emits erasing light. Therefore, the readout light and the erasing light can be emitted with high current efficiency.

Further, the light emission controlling means 40, for separately controlling the operations of the readout light emitting units 25 and the erasing light emitting unit 26, may be provided. In this case, the light emission timing of the readout light emitting units 25 and the light emission timing of the erasing light emitting unit 26 can be controlled independently, even in the case that the readout light source and the erasing light source are integrally formed by employing the multi photon emission element.

The readout light source and the erasing light source may be constituted by an inorganic EL element comprising: a plurality of linear readout light emitting regions formed into stripes; and erasing light emitting regions, which are formed between the readout light emitting regions, as illustrated in FIG. 4. In this case also, dispersion of readout light and reflective loss, due to the readout light being irradiated onto the image recording medium 10 after passing through an interface between the glass substrate and air, can be prevented. Accordingly, generation of flare components of readout light can be suppressed in the image readout apparatus 1, and reduction of light intensity can be prevented.

The present invention is not limited to the embodiments described above. For example, the image readout apparatus 1 of FIG. 1 employs a solid state detector as an example of the image recording medium 10. However, the panel light source 20 may be applied to use for stimulable phosphor sheets as well.

In addition, in the embodiment of FIG. 2, the erasing light and the readout light are both emitted when erasing remaining image information from the image recording medium 10. However, only the erasing light may be emitted at this time. In this case, the CGL 22a may be an ITO film having a conductor, to which switching elements and the drive power source 30 is connected, in order to apply a drive voltage only between the anode 22 and the CGL 22a.

The embodiments of FIG. 2 and FIG. 3 are examples of cases in which multi photo emission elements are employed. However, a first organic EL element that emits readout light (or erasing light) may be stacked as a layer on the substrate 21, and a second organic or an inorganic EL element that emits erasing light (or readout light) may be stacked atop the first organic EL element.

Further, the embodiment of FIG. 1 and FIG. 2 illustrate cases in which the image focusing optical systems 27 are provided between the panel light source 20 and the image recording medium 10. However, a configuration may be adopted, wherein the image recording medium 10 and the panel light source 20 face each other directly, without the image focusing optical system 27 therebetween, as in the embodiments of FIG. 3 and FIG. 4.

What is claimed is:

1. An image readout apparatus for reading image information from an image recording medium, on which the image information is recorded, by irradiating readout light thereon, comprising:
a readout light source constituted by electroluminescence elements, for emitting the readout light onto the image recording medium as line light;
an erasing light source constituted by electroluminescence elements, for emitting erasing light of a frequency different from that of the readout light, to erase the image information recorded on the image recording medium; and
a substrate;
the readout light source and the erasing light source being integrally formed on the substrate.

2. An image readout apparatus as defined in claim 1, wherein:
the readout light source and the erasing light source are constituted by a multi photon emission element, which is integrally formed on the substrate by being stacked as layers thereon.

3. An image readout apparatus as defined in claim 2, further comprising:
light emission control means, for independently controlling the operations of the readout light source and the erasing light source.

4. An image readout apparatus for reading image information from an image recording medium, on which the image information is recorded, by irradiating readout light thereon, comprising:
a readout light source, for emitting the readout light onto the image recording medium as line light;
an erasing light source, for emitting erasing light of a frequency different from that of the readout light, to erase the image information recorded on the image recording medium; and
a substrate;
the readout light source and the erasing light source employing inorganic electroluminescence elements which are integrally formed with the substrate;
the readout light source being constituted by a plurality of stripe regions of the electroluminescence elements that emit light of a readout frequency; and
the erasing light source being constituted by a plurality of linear regions of the electroluminescence elements that emit light of an erasing frequency, which are provided between the stripe regions.
